(19) United States
(12) Patent Application Publication
(10) Pub. No.: US 2024/0416679 A1
(43) Pub. Date: Dec. 19, 2024

(54) AN AUXILIARY WHEEL

(71) Applicant: IW Technologies, LLC, Atlanta, GA (US)

(72) Inventor: Tian Wanzhi, Ningbo (CN)

(73) Assignee: IW Technologies, LLC, Atlanta, GA (US)

(21) Appl. No.: 18/538,296

(22) Filed: Dec. 13, 2023

(30) Foreign Application Priority Data
Jun. 19, 2023 (CN) 2023 215603379

(51) Int. Cl. B60B 27/06; B60B 21/00

(52) U.S. Cl. CPC B60B 27/065; B60B 21/00; B60B 2360/10; B60B 2360/30; B60B 2900/731

(57) ABSTRACT

An auxiliary wheel including a wheel hub and a tire, the wheel hub includes an outer wheel hub and an inner wheel hub and the tire is mounted on the outer wall of the outer wheel hub. The outer wheel hub and the inner wheel hub are detachably connected through a first connection component. When the first connection component unlocks the connection between the outer wheel hub and the inner wheel hub, relative rotation is generated between the outer wheel hub and the inner wheel hub with bearings disposed between the inner wheel hub and the outer wheel hub to reduce friction. Friction is reduced between the outer and inner wheels, thereby increasing the upper limit of the auxiliary wheel rotation speed. A nut and bolt arrangement is disposed in the nut groove to firmly fix the ring on the outer wall of the outer wheel.

### BACKGROUND OF THE INVENTION

With the improvement of living standards, prospective customers would like to purchase a car for family. In addition, traffic accidents may cause cars to become inoperable. At this time, drivers usually will tow their car back to the repair shop. There are three common types of trailers: towing trailer, lifting trailer, and flat trailer. When preparing for the trailer, workers replace the original wheels of the car with auxiliary wheels to facilitate car maintenance or towing.

In the prior art, an auxiliary wheel includes a wheel hub, an outer wheel hub, and an inner wheel hub. The tire is located around the outer circumference of the outer wheel hub. The central part of the outer hub is provided with a through hole extending along its axis, the inner hub is inserted in the through hole, and the outer hub and the inner hub can be detachably connected through the first connection component. When the first connection component unlocks the connection between the outer hub and the inner hub, the relative rotation can be generated between the outer hub and the inner hub. This invention divides the wheel hub into an outer wheel hub and an inner wheel hub. When the connection between the outer wheel hub and the inner wheel hub is released, relative rotation can occur between the outer wheel hub and the inner wheel hub. When towing, there is rolling friction between the tire and the ground with low friction and minimal wear on the tire. However, friction between the outer and inner wheels is prone to limit the speed of the auxiliary wheel rotation, and prolonged friction can easily cause damage to the inner and outer wheels, thereby affecting the user experience.

### SUMMARY OF THE INVENTION

The main technical problem solved by this invention is to provide an auxiliary wheel. When the original wheel hub is locked, the trailer worker only needs do slight treatment for the auxiliary wheel to ensure the auxiliary wheel still rotates in response to existing technical problems.

The utility model provides a technical scheme that above-mentioned technical problem adopted does: an auxiliary wheel, including a wheel hub and a tire, the wheel hub includes an outer wheel hub and an inner wheel hub, the tire is installed on the outer wall of the outer wheel hub, and the outer wheel hub and the inner wheel hub can be detachably connected through the first connection component. When the first connection component removes the connection between the outer wheel hub and the inner wheel hub, the relative rotation can be generated between the outer wheel hub and the inner wheel hub with a bearing between the inner wheel hub and the outer wheel hub to reduce friction.

As an improvement, a fixed clamp strip is installed in the middle section of the inner wheel hub and the inner wall of the bearing is fixed on the fixed clamp strip, and the outer wall of the bearing is fixed on the outer wheel hub.

The inner wheel hub includes a ring that is inserted in the through hole and a mounting plate extends radially from the circumference of the first end of the ring. When the ring is inserted in the bearing through hole, the mounting plate is located outside the through hole and opposes the outer wheel hub. The mounting plate and the outer wheel hub are detachably connected through the first connection component.

The first connecting component is a bolt and a nut capable of threaded connection.

The outer wheel hub is equipped with a nut groove in which a fixing block is installed. The fixing block is rubber wrapped around the nut and the inner wheel hub is equipped with a fixing hole corresponding to the nut groove. The bolt passes through the fixing hole to match the nut.

The second end of the ring extends out of the through hole and the ring is sleeved with a setting circle. The setting ring and the ring are detachably connected through the second connecting component. The setting ring and the mounting plate are respectively located on both sides of the bearing through hole and the setting ring is against the outer wheel hub. The setting ring is attached to the opening of the nut groove.

The second connecting component is a bolt which passes through the setting ring and is tightly connected with the ring.

The central part of the inner wheel hub forms an installation hole for mounting shaft which is a step hole allowing shafts with different end diameters to be installed in the installation hole.

The installation hole includes at least two holes that gradually increase in diameter along the axial direction of the inner wheel hub.

The outer wheel hub is a plastic component and the inner wheel hub is a metal component.

Finally, the tire is a rubber component that is integrally formed on the outer wheel hub.

Compared with the prior art, this invention has the advantages of reducing the friction force between the outer wheel hubs and inner wheel hubs by setting a bearing therebetween, thereby increasing the upper limit of the auxiliary wheel rotation speed. The nut and bolt in the nut groove firmly fix the annular body on the outer wall of the outer wheel hub, making it difficult to detach, making the connection more stable and reliable, and convenient to disassemble the bolt. After the bolt of the first connecting component is removed, the fixing block with the nut is stuck on the nut groove. In addition to the limitation of the setting ring, the fixing block with nuts will not come out of the nut groove. Therefore, when the tire is converted from the outer wheel hub and the inner wheel hub to the relatively rotating and no rotating state, it can be achieved only through the loading and unloading of the external bolts. It does not need to remove the tire from the vehicle. It has simple structure, convenient installation and use, low friction, and low tire wear.

### BRIEF DESCRIPTION OF THE DRAWINGS

FIG. 1 is an exploded perspective view of this invention;

FIG. 2 is a front plan view thereof;

FIG. 3 is a rear plan view thereof;

FIG. 4 is a perspective view of the inner wheel hub structure; and

FIG. 5 is a perspective view of the setting circles.

### DETAILED DESCRIPTION OF THE INVENTION

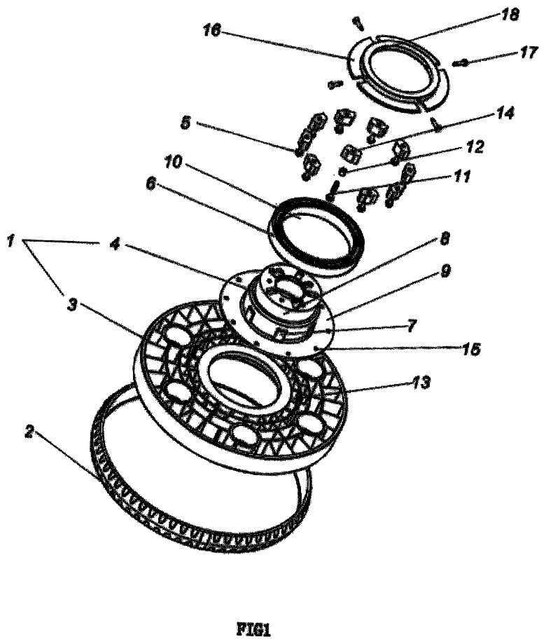

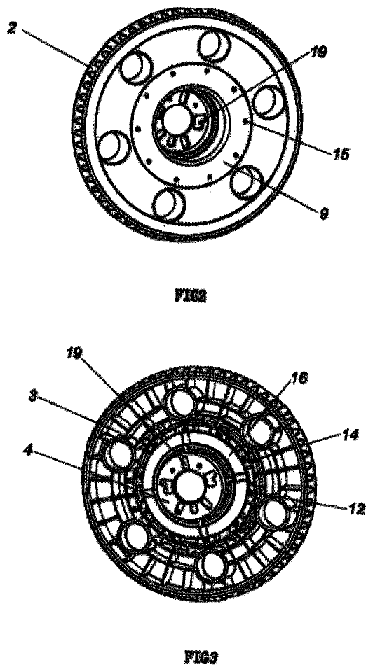

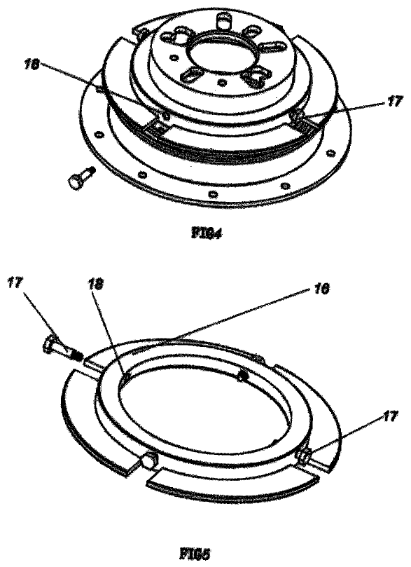

As shown in FIGS. 1-5, an auxiliary wheel includes a wheel hub 1 and a tire 2. The wheel hub 1 includes an outer wheel hub 3 and an inner wheel hub 4. The tire 2 is mounted on the outer wall of the outer wheel hub 3 and the outer wheel hub 3 and the inner wheel hub 4 are detachably connected through the first connection component 5. When the first connection component 5 unlocks the connection between the outer wheel hub 3 and the inner wheel hub 4, relative rotation is generated between the outer wheel hub 3 and the inner wheel hub 4. Bearings 6 reduce friction between the inner wheel hub 4 and the outer wheel hub 3.

The middle section of the inner wheel hub 4 is equipped with a fixed clamp strip 7 and the bearing 6 has a bearing through hole 10. Its inner wall is fixed on the fixed clamp strip 7 which increases the firmness with the inner wall of the bearing 6. The outer wall of the bearing 6 is fixed to the outer wheel hub 3.

Inner wheel hub 4 includes ring 8 that is inserted into the bearing through hole 10 and mounting plate 9 extends radially from the circumference of the first end of ring 8. When ring 8 is inserted into the bearing through hole 10, mounting plate 9 is located on the outside of the through hole 10 and opposes outer wheel hub 3. Mounting plate 9 and outer wheel hub 3 are detachably connected through the first connection component 5 and a bolt 11 and nut 12 are threaded.

Outer wheel hub 3 is equipped with nut groove 13 along the circumference and fixing block 14 is installed in nut groove 13. Fixing block 14 is rubber wrapped around nut 12. Mounting plate 9 of inner wheel hub 4 is equipped with fixing hole 15 corresponding to nut groove 13 and bolt 11 passes through fixing hole 15 to match nut 12. Fixing block 14 is firmly embedded in nut groove 13.

The second end of ring 8 extends out of the through hole 10 and ring 8 is sleeved with setting ring 16. Setting ring 16 and ring 8 are detachably connected through second connecting component 17. Second connecting component 17 is the second bolt which is tightly connected with ring 8 through setting ring 16 and the second bolt is threaded to threaded hole 18 of setting ring 16 and firmly supports the outer peripheral surface of ring 8. Setting ring 16 and mounting plate 9 are respectively located on both sides of the bearing through hole 10, and setting ring 16 is against outer wheel hub 3. Setting ring 16 is attached to the opening of nut groove 13 to prevent fixing block 14 from leaving nut groove 13.

The central part of inner wheel hub 4 is formed with an installation hole 19 for installing the shaft. Installation hole 19 is a step hole which is used for installing shafts with different end diameters in the installation hole 19. Installation hole 19 includes at least two holes that gradually increase in diameter along the axial direction of inner wheel hub 4.

The outer wheel hub 3 of wheel hub 1 is made of plastic with a large number of hollow areas and reinforcing ribs inside the outer wheel hub 3. Without reducing its firmness, the cost is low and the weight is light making it easy for users to lift it. The inner wheel hub 4 provides sufficient strength for metal parts to increase its service life. The tire 2 is a rubber part integrally formed on the outer wheel hub 3, improving the tire's torque resistance, grip, and resistance to friction.

When using the auxiliary wheel, tools are needed to remove the wheel on the vehicle and install the auxiliary wheel on the wheel shaft. After installing mounting hole 19 into the fixed position on the wheel shaft and locking it firmly, setting ring 16 is removed and bolt 11 on inner wheel hub 4 and inner wheel nut 12 on fixing block 14 of outer wheel hub 3 are turned away to achieve the effect of loosening first connection component 5 which allows the inner wheel hub 4 and outer wheel hub 3 to rotate independently to avoid mutual interference. Bearing 6 can increase the rotational speed of outer wheel hub 3 and tire 2, making it easier for consumers to move faulty vehicles. After bolt 11 of the first connecting component 5 is removed, the fixing block 14 with nuts is stuck on the nut groove. With the restriction of the setting ring 16, fixing block 14 with nuts 12 will not come out of the nut groove 13.

Therefore, when the tire is converted from the outer wheel hub 3 to inner wheel hub 4 in the relative rotation and no rotation state, it is achieved only through the loading and unloading of the outer bolts, without having to remove the tire from the vehicle which is more convenient.

The foregoing is only a preferred embodiment of the present invention and it should be noted that, for those skilled in the art, a plurality of improvements and can be made without departing from the technical principle of the present invention and these improvements are within the scope of the present invention.

1. An auxiliary wheel comprises a wheel hub and a tire, the wheel hub includes an outer wheel hub and an inner wheel hub, the tire is mounted on the outer wall of the outer wheel hub, and the outer wheel hub and the inner wheel hub are detachably connected through a first connection component, when the first connection component unlocks the connection between the outer wheel hub and the inner wheel hub, relative rotation is generated between the outer wheel hub and the inner wheel hub, and a bearing is disposed between the inner wheel hub and the outer wheel hub to reduce friction.

2. The auxiliary wheel according to claim 1 wherein the middle section of the inner wheel hub is equipped with a fixed clamp strip, the inner wall of the bearing is fixed on the fixed clamp strip, and the outer wall of the bearing is fixed on the outer wheel hub.

3. The auxiliary wheel according to claim 1 wherein the inner wheel hub includes a ring that is inserted in the bearing through hole and a mounting plate that extends radially from the circumference of the first end of the ring, when the ring is inserted in the bearing through hole, the mounting plate is located outside the through hole and opposes the outer wheel hub, and the mounting plate and the outer wheel hub are detachably connected through the first connecting component.

4. The auxiliary wheel according to claim 3 wherein the first connecting component is a bolt and a nut that are threaded.

5. The auxiliary wheel according to claim 4 wherein the outer wheel hub is provided with a nut groove, a fixing block is provided in the nut groove, said fixing block is rubber wrapped around the nut, the inner wheel hub is provided with a fixing hole corresponding to the nut groove, and said bolt passes through the fixing hole and matches with said nut.

6. The auxiliary wheel according to claim 5 wherein the second end of the ring extends out of the bearing through hole, the ring is sleeved with a setting ring, the setting ring and the ring are detachably connected through the second connecting component, the setting ring and the mounting plate are respectively located on both sides of the bearing through hole, the setting ring is opposed to the outer wheel hub, and the setting ring is attached to the opening of the nut groove.

7. The auxiliary wheel according to claim 6 wherein the second connecting component is a bolt which passes through the setting ring and is tightly connected with the ring.

8. The auxiliary wheel according to claim 1 wherein an installation hole for installing a shaft is formed in the center of the inner wheel hub, and the installation hole is a step hole used for installing shafts with different end diameters in the installation hole.

9. The auxiliary wheel according to any of claim 1 wherein the installation hole comprises at least two holes gradually increasing in diameter along the axial direction of the inner wheel hub.

10. The auxiliary wheel according to claim 1 wherein the outer wheel hub is a plastic component and the inner wheel hub is a metal component.
